(19) United States
(12) Patent Application Publication
(10) Pub. No.: US 2015/0208859 A1
(43) Pub. Date: Jul. 30, 2015

(54) SELF-HEATING OR COOLING TUBE CONTAINER

(71) Applicants: Nan-Chieh WANG, Shenzhen (CN); UDN PACKAGING CORP., Shenzhen (CN)

(72) Inventor: Nan-Chieh WANG, Shenzhen (CN)

(21) Appl. No.: 14/526,655

(22) Filed: Oct. 29, 2014

(30) Foreign Application Priority Data
Jan. 26, 2014 (CN) 201410038098.X

(51) Int. Cl. A47J 36/28; F24J 1/00; F25D 31/00; F25D 5/02

(52) U.S. Cl. CPC A47J 36/28; F25D 5/02; F24J 1/00; F25D 31/005; F25D 31/002

(57) ABSTRACT

A self-heating or cooling tube container, which comprises a heat generating or absorbing device. The device includes: a tube provided with a tube head, in which a storage cup is extended out of an upper end of the tube head; a first component and a second component for exothermic or endothermic reaction are respectively accommodated into an inner cavity of the tube and the storage cup sealed with a plug. The container further comprises an outer tube with a screw-on cap that inner have a convex ring and lower edge have a safety belt; when the safety belt is torn off and the outer tube is locked by the cap, the first component and the second component make contact with each other to produce an exothermic or endothermic reaction, and the liquid content in the outer tube can be heated or cooled. The container is applicable to pack medicines or cosmetics.

### FIELD OF THE INVENTION

The present invention relates to a self-heating or cooling tube container, in which a heat generating or absorbing device is installed into an outer tube containing a liquid content; and when the tube container is used, the device generates or absorbs heat spontaneously to raise or reduce the temperature of the liquid content.

### BACKGROUND OF THE INVENTION

Packaging containers capable of automatically heating or cooling without external energy have been available for several decades, but products which can be safely used and have high performance are rare. Moreover, the production cost is relatively high, and the products cannot be conveniently recycled.

The U.S. Pat. No. 7,942,145 utilizes the exothermic reaction in the process of the recrystallization of supersaturated solution of sodium acetate to heat milk in a bottle. The initial method of the heating reaction adopts the collision of two porcelain beads. The container has a complex structure and high production cost and is not applicable to be a disposable container.

In a self-heating or self-cooling beverage can of the U.S. Pat. No. 4,751,119, a reaction chemical product and an initiator are separated from each other by a glass sheet. The user pushes the bottom of the can to trigger the reaction then drinks the content from the top of the can. The container is not applicable to high-viscosity paste.

Commercially available electrical thermal bags and packages for heating or cooling food and beverage are mostly flexible pouches or rigid plastic or metal containers. General rigid containers required for heat or cold application have fixed capacity. If the capacity is required to be changed, the rigid container must be replaced. The change of the capacity inevitably brings about high cost, e.g., high cost of molds and accessories and labor cost.

At present, none commercially available flexible containers applicable for medicines and cosmetics have the self-heat generating or absorbing function. When medicines and cosmetics required for heat or cold application are required, an external heating or cooling source has to be adopted for heating or cooling, the containers are inconvenient to use.

### SUMMARY OF THE INVENTION

The objective of the present invention is to provide a self-heating or cooling tube container, in which a heat generating or absorbing device is installed in an outer tube; and when the tube container is used, the device generates or absorbs heat spontaneously to raise or reduce the temperature of a liquid content in the outer tube.

The other objective of the present invention is to provide a flexible packing with heat generating or absorbing device to enhance the requirement of being cooperated with the tube container.

A self-heating or cooling tube container, comprising:

a heat generating or absorbing device, in which the device includes a tube provided with a tube head, a first component and a second component for exothermic or endothermic reaction, and a plug provided with a pointed cone, a storage cup the bottom of which can be pierced is extended out of an upper end of the tube head; the first component and the second component are respectively accommodated into an inner cavity of the tube and the storage cup; and the plug is inserted into the storage cup and seals the storage cup;
an outer tube containing a liquid content, in which the heat generating or absorbing device is installed into the outer tube; and
a screw-on cap, in which a convex ring is disposed in the screw-on cap; a safety belt for preventing the convex ring from pushing the plug is disposed on a lower edge of the screw-on cap; and when the safety belt is torn off and the outer tube is locked by the screw-on cap, the convex ring pushes the plug to pierce the bottom of the storage cup, so that the first component and the second component will contact with each other to produce an exothermic or endothermic reaction, and hence the liquid content can be heated or cooled

Wherein, the plug includes a cylindrical portion, and a disc portion and the pointed cone which are respectively disposed on an upper end and a lower end of the cylindrical portion; and the cylindrical portion is slideably engaged with the inner wall of the storage cup and seal the storage cup.

The taper of the pointed cone of the plug is 10 to 30 degrees.

The pointed cone of the plug is preferably in the shape of a triangular pyramid; a recessed portion is formed between two adjacent edges; and after the bottom of the storage cup is pierced, the recessed portion may take the second component to run through and enter the inner cavity of the tube of the heat generating or absorbing device.

The thickness of the bottom of the storage cup is 0.2 to 1.5 mm, preferably 0.3 to 0.95 mm.

Two liquid outlet channels are formed on the outside of the tube head of the heat generating or absorbing device, an outer ring rib is formed on an edge of the tube head; a connecting shell provided with inside threads is winded on the periphery of the convex ring in the screw-on cap; the outer wall of a outer tube head of the outer tube is provided with outside threads to be engaged with the inside threads of the screw-on cap; the inner wall of the outer tube head is provided with a ring groove buckled with the outer ring rib of the tube head of the heat generating or absorbing device.

The distance between a lower surface of the convex ring in the screw-on cap and a lower surface of the safety belt is 1 to 1.05 times of the distance between an upper end surface of the plug and a retaining surface of the outer tube head of the outer tube.

The tube in the heat generating or absorbing device adopts a polyethylene (PE) plastic tube, a polypropylene (PP) plastic tube, an aluminum laminate tube, a metal tube or the like.

The outer tube is composed of the outer tube head and a tube body; and the tube body may adopt a PE plastic tube, a PP plastic tube, an aluminum laminate tube, a metal tube or the like.

The first component and the second component for exothermic reaction are preferably supersaturated solution of sodium acetate and crystals of sodium acetate respectively; and the first component and the second component for endothermic reaction are preferably urea and water respectively.

The first component for endothermic reaction also may be a known material such as anhydrous calcium chloride, calcium chloride, calcium oxide and potassium chloride; and correspondingly, the second component is water.

The present invention relates to a heat generating or absorbing device for the tube container, which comprises: a tube provided with a tube head, in which a storage cup the bottom of which can be pierced is extended out of an upper end of the tube head; a first component and a second component for exothermic or endothermic reaction, in which the first component and the second component for exothermic or endothermic reaction are respectively accommodated into an inner cavity of the tube and the storage cup; and, a plug provided with a pointed cone, in which the plug provided with the pointed cone is inserted into the storage cup and seals the storage cup.

Wherein, the thickness of the bottom of the storage cup is 0.2 to 1.5 mm; a pointed cone of the plug is in the shape of a triangular pyramid with the taper of 10 to 30 degrees; and a recessed portion is formed between two adjacent edges so as to take the second component to run through.

The heat generating or absorbing device is installed in the outer tube of the tube container provided by the present invention. The container is applicable to tube packages of medicines or cosmetics required for heat or cold application. When the tube container is used, the device spontaneously generates or absorbs heat to raise or reduce the temperature of the liquid content in the outer tube.

The packaging of the heat generating or absorbing device also adopt flexible tube packing. The amount of first component can be determined by the required service temperature of the content liquid in outer tube. When the capacity of inner cavity is required to be adjusted, the length of flexible tube can be adjusted accordingly. In the process of manufacturing the tube, the molds need not to be changed, so that the mold cost and the labor cost can be saved.

The tube container may use a conventional tube filling equipment to fill the content and meanwhile seal the tube, for mass-production.

### BRIEF DESCRIPTION OF THE DRAWINGS

FIGS. 1 and 2 are respectively a perspective view and an exploded view of an embodiment of a self-heating or cooling tube container provided by the present invention;

FIG. 3 is a schematic diagram illustrating an internal structure of the embodiment as shown in FIG. 1;

FIG. 4 is a state diagram illustrating the state before and after the bottom of a storage cup is pierced by a plug provided with a pointed cone, in which the left side indicates that a first component and a second component do not react when the bottom of the storage cup is not pierced, and the right side indicates that the first component and the second component make full contact with each other and react when the bottom of the storage cup is pierced, and reaction occurred.

FIG. 5 is a perspective view of a plastic plug provided with a pointed cone, as show in FIG. 2.

### DETAILED DESCRIPTION OF THE PREFERRED EMBODIMENTS

Detailed description will be given to the present invention with reference to the preferred embodiments.

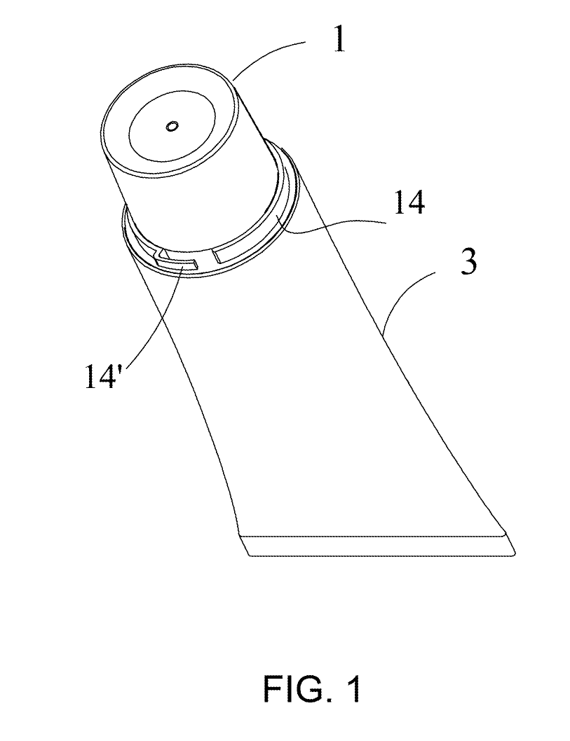

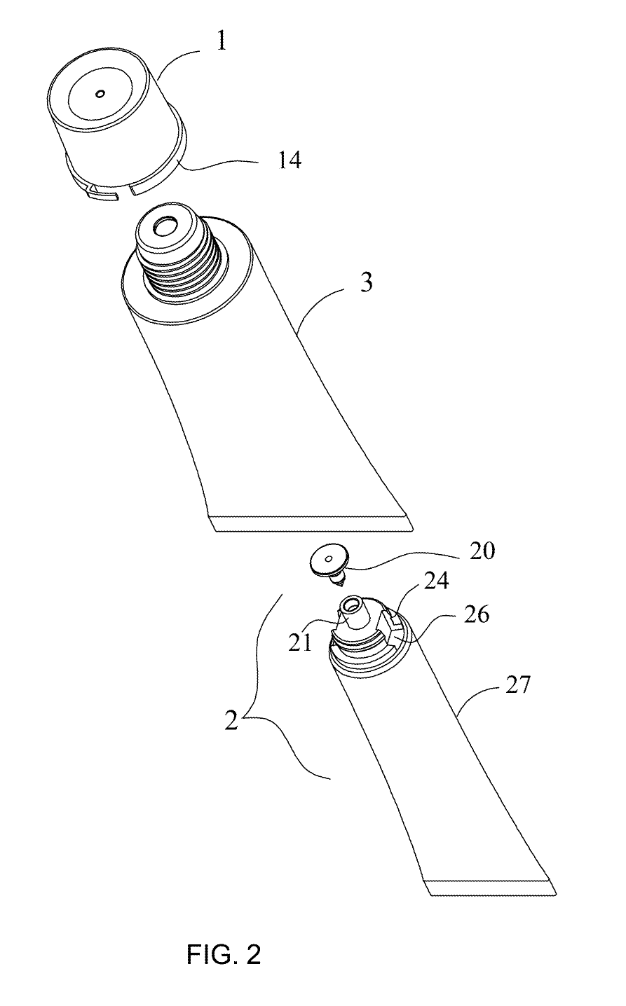

As illustrated in FIGS. 1 to 3, the embodiment of the self-heating or cooling tube container comprises: an outer tube 3 containing a liquid content, a heat generating or absorbing device 2 installed in the outer tube 3, and a screw-on cap 1 capable of being locked with the outer tube.

The heat generating or absorbing device 2 includes a tube 27 provided with a tube head 25, a first component 28 and a second component 22 for exothermic or endothermic reaction, and a plug 20 provided with a pointed cone; a storage cup 21 the bottom 23 of which can be pierced is extended out of an upper end of the tube head 25; the first component 28 and the second component 22 for exothermic or endothermic reaction are respectively accommodated into an inner cavity of the tube 27 and the storage cup 21; and the plug 20 provided with the pointed cone is inserted into the storage cup 21 and seals the storage cup 21. Two liquid outlet channels 26 are symmetrically formed on the outside of the tube head 25, and an outer ring rib 24 is formed on the edge of the tube head 25. The thickness of the bottom of the storage cup 21 may be 0.2 to 1.5 mm, preferably 0.3 to 0.95 mm. The tube 27 adopts a PE plastic tube, a PP plastic tube, an aluminum laminate tube, a metal tube or the like.

A convex ring 11 is disposed in the screw-on cap 1; a connecting shell 12 provided with inside threads 13 is winded on the periphery of the convex ring 11; a tear-off safety belt 14 is disposed on a lower edge of the screw-on cap 1; and when the screw-on cap 1 locks the outer tube (in the unused state), the safety belt 14 is configured to prevent the convex ring 11 in the screw-on cap from pushing the plug 20 to pierce the bottom 23 of the storage cup 21.

The outer tube 3 is composed of a outer tube head 31 and a tube body 34. The tube body 34 may adopt a PE plastic tube, a PP plastic tube, an aluminum laminate tube, a metal tube or the like. A liquid content such as cosmetics and liquid medicines is filled in the tube body 34. The outer wall of the outer tube head 31 is provided with outside threads 32 engaged with the inside threads 13 in the screw-on cap 1, and the inner wall is provided with a ring groove 33 buckled with the outer ring rib 24 of the tube head 25 of heat generating or absorbing device 2.

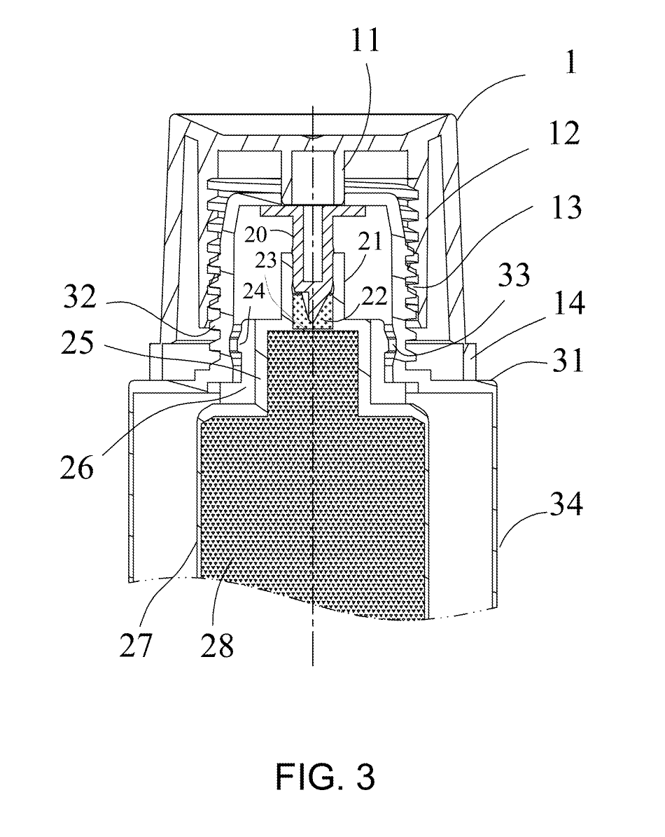

The heat generating or absorbing device 2 is installed in the outer tube 3; the outer ring rib 24 on the edge of the tube head 25 is snapped into the ring groove 33 of the outer tube head 31; and the liquid outlet channels 26 on the outside of the tube head 25 is communicated with the inner cavity of the tube body 34 of the outer tube 3. The screw-on cap 1 is threadedly connected to the outer tube head 31 of the outer tube 3 through the connecting shell 12 with the inside threads 13. The distance between a lower surface of the convex ring 11 in the screw-on cap 1 and a lower surface of the safety belt 14 is 1 to 1.05 times of the distance between an upper end surface of the plug 20 and the retaining surface of the outer tube head 31, so as to ensure that the bottom 23 of the storage cup 21 cannot be pierced by the pointed cone of the plug 20 as shown in FIG. 3.

In the heat generating or absorbing device 2, the second component 22 for exothermic or endothermic reaction is filled in the storage cup 21; the corresponding first component 28 is filled in the cavity of the tube 27; and the amount of the first component and the second component is determined by the required service temperature of the liquid content of the outer tube 3. The length and diameter of the device 2 can be appropriately adjusted to meet the required service temperature of the liquid content of the outer tube 3.

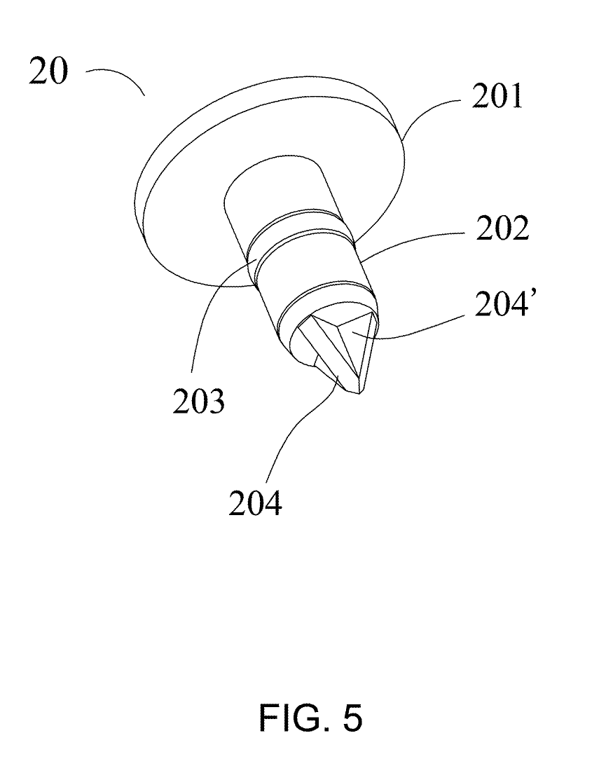

As illustrated in FIG. 5, the plastic plug 20 provided with the pointed cone includes a cylindrical portion 202, and a disc portion 201 and a pointed cone 204 which are respectively disposed on an upper end and a lower end of the cylindrical portion 202; a leakproof ring 203 for sealing the storage cup is disposed on the cylindrical portion 202; and the cylindrical portion 202 is slideably engaged with an inner wall of the storage cup 21. The pointed cone 204 of the plastic plug 20 is in the shape of a triangular pyramid with the taper of 10 to 30 degrees; and a recessed portion 204′ is formed between two adjacent edges so as to take the second component 22 to run through.

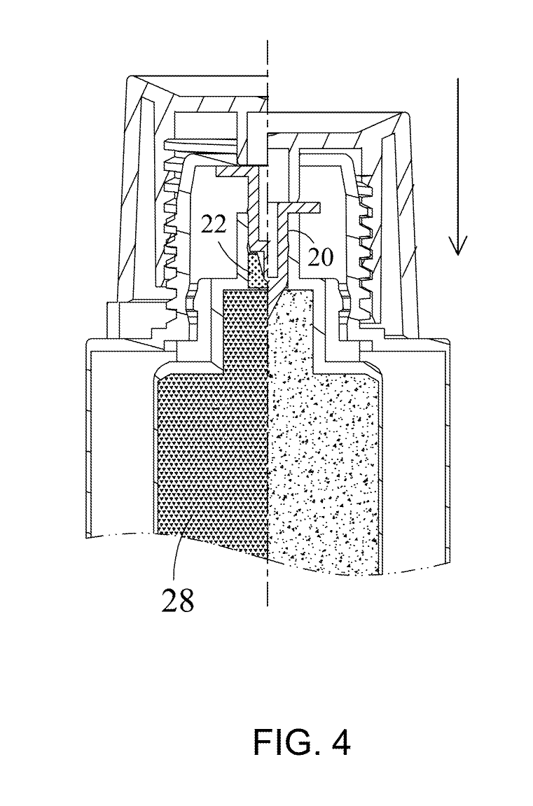

FIG. 4 is a state diagram illustrating the state before and after the bottom of the storage cup 21 is pierced by the plug 20 provided with the pointed cone 204, in which the left side indicates that the first component and the second component do not react when the bottom of the storage cup is not pierced, and the right side indicates that the first component and the second component make full contact with each other and reaction occurred when the bottom of the storage cup is pierced by plug 20.

When the tube container is used, the safety belt 14 on the lower edge of the screw-on cap 1 is torn off; the screw-on cap 1 is rotatably locked to the tube head portion 31 of the outer tube 3; at this point, when the screw-on cap 1 is locked, the convex ring 11 in the screw-on cap slides through the orifice of the outer tube head 31 and will push down the plug 20 provided with the pointed cone; and the pointed cone 204 is driven to pierce the bottom 23 of the storage cup 21, so that the second component 22 in the storage cup 21 can enter the inner cavity of the tube 27 and make contact with the first component 28 to produce an exothermic or endothermic reaction, and hence the temperature of the liquid content in the outer tube 3 can be raised or reduced. When the temperature of the liquid content in the outer tube 3 reaches the required service temperature, the screw-on cap 1 can be unscrewed to squeeze the liquid content in the outer tube 3 for useing.

When the tube container is not used (as shown in FIG. 3), the plug 20 provided with the pointed cone is inserted into the storage cup 21 for accommodating the second component 22; the leakproof ring 203 on the cylindrical portion 202 is disposed on an inlet edge of the storage cup 21 and can help the cylindrical portion to completely seal the storage cup 21; and the first component 28 for exothermic or endothermic reaction is filled in the cavity of the tube 27. Therefore, the first component and the second component will not be leaked before and after reaction, and hence the phenomenon that the first component and the second component leak out to contaminate the liquid content in the outer tube 3 can be prevented.

With the structure of the embodiment as shown in FIG. 1 to be tested as follows:

In the embodiment as shown in FIG. 1, the first component and the second component of the heat generating device 2 are respectively 25 ml supersaturated solution of sodium acetate and 1 g crystals of sodium acetate; 25 ml water is filled in the outer tube 3; and three samples 1#, 2# and 3# are taken and tested at the room temperature of 17° C., with the results as shown in Table 1:

TABLE 1

| | Water Temperature | Water Temperature | |
|---|---|---|---|
| | Before Exothermic | After Exothermic | Temperature |
| | Reaction | Reaction | Difference |
| Sample 1# | 19° C. | 38° C. | 19° C. |
| Sample 2# | 19° C. | 37° C. | 18° C. |
| Sample 3# | 20° C. | 39° C. | 19° C. |

The water in the outer tube 3 is heated by heat discharged after exothermic reaction and the water temperature is raised by 18 to 19° C., so that the heating effect is obvious.

In the embodiment as shown in FIG. 1, the first component and the second component of the heat absorbing device 2 are respectively 20 g urea and 10 ml water; 25 ml water is filled in the outer tube 3; and a sample is taken and tested at the room temperature of 25.5° C., with the results as follows: before endothermic reaction, the water temperature of the outer tube is 25.5° C.; after endothermic reaction, the water temperature of the outer tube is reduced to 8.2° C.; so the water temperature is reduced by 17.3° C.; and hence the cooling effect is obvious.

Detailed description has been given above to the present invention with reference to the preferred embodiments, but the present invention is not limited to the contents of these embodiments. Any improvement and equivalent made by ttube skilled in the art on the basis of the concept and the description of the present invention and in conjunction with the knowledge in the art should all fall within the scope of protection of the claims of the present invention.

What is claimed is:

1. A self-heating or cooling tube container, comprising:
a heat generating or absorbing device, in which the device includes a tube provided with a tube head, a storage cup the bottom of which can be pierced is extended out of an upper end of the tube head, a plug, a first component and a second component for exothermic or endothermic reaction are respectively accommodated into an inner cavity of the tube and the storage cup; and the plug is inserted into the storage cup and seals the storage cup;
an outer tube containing a liquid content, in which the heat generating or absorbing device is installed into the outer tube; and
a screw-on cap, in which a convex ring is disposed in the screw-on cap; a safety belt for preventing the convex ring from pushing the plug is disposed on a lower edge of the screw-on cap; and when the safety belt is torn off and the outer tube is locked by the screw-on cap, the convex ring pushes the plug to pierce the bottom of the storage cup, so that the first component and the second component make contact with each other to produce an exothermic or endothermic reaction, and hence the liquid content can be heated or cooled.

2. The tube container according to claim 1, wherein the plug includes a cylindrical portion, and a disc portion and a pointed cone which are respectively disposed on an upper end and a lower end of the cylindrical portion; and the cylindrical portion is sealing the storage cup.

3. The tube container according to claim 2, wherein the taper of the pointed cone of the plug is 10 to 30 degrees; and the thickness of the bottom of the storage cup is 0.2 to 1.5 mm.

4. The tube container according to claim 2, wherein the pointed cone of the plug is in the shape of a triangular pyramid; a recessed portion for taking the second component to run through is formed between two adjacent edges; and the thickness of the bottom of the storage cup is 0.3 to 0.95 mm.

5. The tube container according to claim 1, wherein the taper of a pointed cone of the plug is 10 to 30 degrees; and the thickness of the bottom of the storage cup is 0.2 to 1.5 mm.

6. The tube container according to claim 1, wherein a pointed cone of the plug is in the shape of a triangular pyramid; a recessed portion for taking the second component to run through is formed between two adjacent edges; and the thickness of the bottom of the storage cup is 0.3 to 0.95 mm.

7. The tube container according to claim 1, wherein two liquid outlet channels are formed on the outside of the tube head of the device; an outer ring rib is formed on an edge of the tube head; a connecting shell provided with inside threads is winded on the periphery of the convex ring in the screw-on cap; the outer wall of a outer tube head of the outer tube is provided with outside threads to be engaged with the inside threads of the screw-on cap; and the inner wall of the outer tube head is provided with a ring groove buckled with the outer ring rib of the tube head of the device.

8. The tube container according to claim 1, wherein the distance between a lower surface of the convex ring in the screw-on cap and a lower surface of the safety belt is 1 to 1.05 times of the distance between an upper end surface of the plug and a retaining surface of a outer tube head of the outer tube.

9. The tube container according to claim 1, wherein the tube adopts a polyethylene (PE) plastic tube, a polypropylene (PP) plastic tube, an aluminum laminate tube, a metal tube or the like.

10. The tube container according to claim 1, wherein the first component and the second component for exothermic reaction are respectively supersaturated solution of sodium acetate and crystals of sodium acetate; and the first component and the second component for endothermic reaction are respectively urea and water.

11. A heat generating or absorbing device for the tube container according to claim 1, comprising:
a tube provided with a tube head, in which a storage cup the bottom of which can be pierced is extended out of an upper end of the tube head; a first component and a second component for exothermic or endothermic reaction, in which the first component and the second component are respectively accommodated into the inner cavity of the tube and the storage cup; and, a plug provided with a pointed cone, in which the plug is inserted into the storage cup and seals the storage cup.

12. The heat generating or absorbing device according to claim 11, wherein the thickness of the bottom of the storage cup is 0.2 to 1.5 mm; the pointed cone of the plug is in the shape of a triangular pyramid with the taper of 10 to 30 degrees; and a recessed portion is formed between two adjacent edges so as to take the second component to run through.

13. The heat generating or absorbing device according to claim 11, wherein the tube adopts a polyethylene (PE) plastic tube, a polypropylene (PP) plastic tube, an aluminum laminate tube, a metal tube or the like.

14. The heat generating or absorbing device according to claim 11, wherein the first component and the second component for exothermic reaction are respectively supersaturated solution of sodium acetate and crystals of sodium acetate; and the first component and the second component for endothermic reaction are respectively urea and water.
